(19) United States
(12) Patent Application Publication
(10) Pub. No.: US 2016/0032465 A1
(43) Pub. Date: Feb. 4, 2016

(54) PRESSURE INDUCED CYLINDRICAL GAS GENERATOR SYSTEM FOR THE ELECTROLYSIS OF AMMONIUM HYDROXIDE

(71) Applicant: Kenny KERSTIENS, Denver, CO (US)

(72) Inventor: Kenny Kerstiens, Denver, CO (US)

(21) Appl. No.: 14/776,254

(22) PCT Filed: Mar. 17, 2014
(86) PCT No.: PCT/US14/30919

§ 371 Date: Sep. 14, 2015

Related U.S. Application Data
(60) Provisional application No. 61/792,641, filed on Mar. 15, 2013.

(51) Int. Cl. C25B 9/08; C25B 1/02; F02D 41/14; C25B 11/02; F02B 43/10; F02D 41/00; C25B 13/02; C25B 1/00

(52) U.S. Cl. CPC C25B 9/08; C25B 13/02; C25B 1/02; C25B 1/00; C25B 11/02; F02B 43/10; F02D 41/0027; F02D 41/144; F02B 2043/106

(57) ABSTRACT

A combination air pressure system and a gas generator system adapted for mounting next to an intake manifold of a tubocharged diesel engine. The system includes a solution reservoir tank for supplying a fluid mixture to a gas generator. The gas generator includes a housing with a plurality concentric tubular electrodes consisting of both anode and cathode tubular electrodes with a series of interposed bipolar electrodes.

### CROSS-REFERENCE TO RELATED APPLICATIONS

This application claims priority to and the benefit of U.S. provisional application No. 61/792,641, entitled “Pressure Induced Cylindrical Gas Generator System For the Electrolysis of Ammonium Hydroxide”, which was filed on Mar. 15, 2013, and which is hereby incorporated by reference in its entirety for all purposes.

### TECHNICAL FIELD

The present disclosure is generally directed to a pressurized gas generation system used to improve the performance of an engine.

### BACKGROUND

Heretofore, there have been a large number of references directed to hydrogen gas generation for internal combustion engines. These references disclose complex and expensive apparatus and methods for generating hydrogen gas using an electrolysis cell and may even require a major redesign of a standard diesel engine and the engine's exhaust system.

The foregoing and other objects, features, and advantages of the invention will become more apparent from the following detailed description, which proceeds with reference to the accompanying figures.

### SUMMARY

The present disclosure relates to a device and system for producing gas. The gas generator may be used with a diesel engine. It may include a body and a first end cap having a flat recessed surface connected to a first end of the body. The gas generator may include a second end cap connected to a second end of the body. The body may have an anode bar that extends along a central axis of the body. The body may have a plurality of concentric bipolar conductive tubes that surround the anode bar and seat on the flat recessed surface of the first end cap. The body may have a cathode tube that surrounds the bipolar conductive tubes and forms an exterior surface of the body.

In various embodiments gases produced by a pressurized electrolytic cell containing mixtures of ammonium hydroxide may be introduced into an intake air stream of an internal combustion engine. The gases produced by electrolysis and introduced into intake stream may be, by way of example and not limitation, a mixture of hydrogen, oxygen, nitrogen and other gas species.

Various embodiments are directed to a system that combines a pressurized air mechanism and a gas generator. The gas generator is fed a fluid mixture from a solution reservoir tank that holds the fluid mixture. The fluid mixture undergoes electrolysis in the gas generator, producing a gas or gas mixture that is fed back to the solution reservoir tank. The pressure mechanism then supplies air under pressure to the solution reservoir tank which pressurizes the complete system. The pressurized gas mixture is then introduced into the intake air stream of an internal combustion engine. The system may be adapted for mounting to the body or under the hood of a truck or similar vehicle and next to the intake manifold of a diesel engine.

In various embodiments, the system includes an on/off switch and amp meter. The switch may connect to the vehicle's battery. When the system is turned “on”, power is supplied to the gas generator for generating a mixture of gases. The air pressure system may include an airline connected to a vehicle's high pressure airline or to an on-board compressor system. An air pressure regulator may connect to the air line for adjusting the system pressure. The airline then connects to the solution reservoir tank for pressurizing the entire system including the gas mixture before it is introduced in the engine's air intake manifold.

The gas generator may include a generator housing that contains a plurality of spaced apart anode and cathode electrode tubes. The tubes are fed fluid from the reservoir tank and provide the electrolysis gas as output. The tubes include a number of concentric cylindrical surfaces that operate to perform electrolysis on the fluid introduced into the gas generator.

### BRIEF DESCRIPTION OF THE DRAWINGS

FIG. 1 is a schematic illustration of a combination air pressure and gas generator system in accordance with embodiments discussed herein;

FIG. 2 is a perspective illustration of an embodiment of the gas generator shown in FIG. 1;

FIG. 3 is an exploded view of the gas generator shown in FIG. 2;

FIG. 4 is a cross-sectional illustration of the gas generator shown in FIG. 2;

FIG. 5A is a perspective view of the end cap show in FIG. 3;

FIG. 5B is a reverse perspective view of the end cap shown in FIG. 5A;

FIG. 6 is a schematic illustration of a combination air pressure and gas generator system in accordance with embodiments discussed herein;

FIG. 7 is a perspective illustration of an embodiment of the gas generator shown in FIG. 6;

FIG. 8 is an exploded view of the gas generator shown in FIG. 7;

FIG. 9 is a cross-sectional illustration of the gas generator shown in FIG. 7;

FIG. 10A is a perspective view of the end cap shown in FIG. 7;

FIG. 10B is a reverse perspective view of the end cap shown in FIG. 10A; and

FIG. 11 is a schematic illustration of a power supply circuit for providing power to the combination air pressure and gas generator system of FIG. 6.

### DETAILED DESCRIPTION

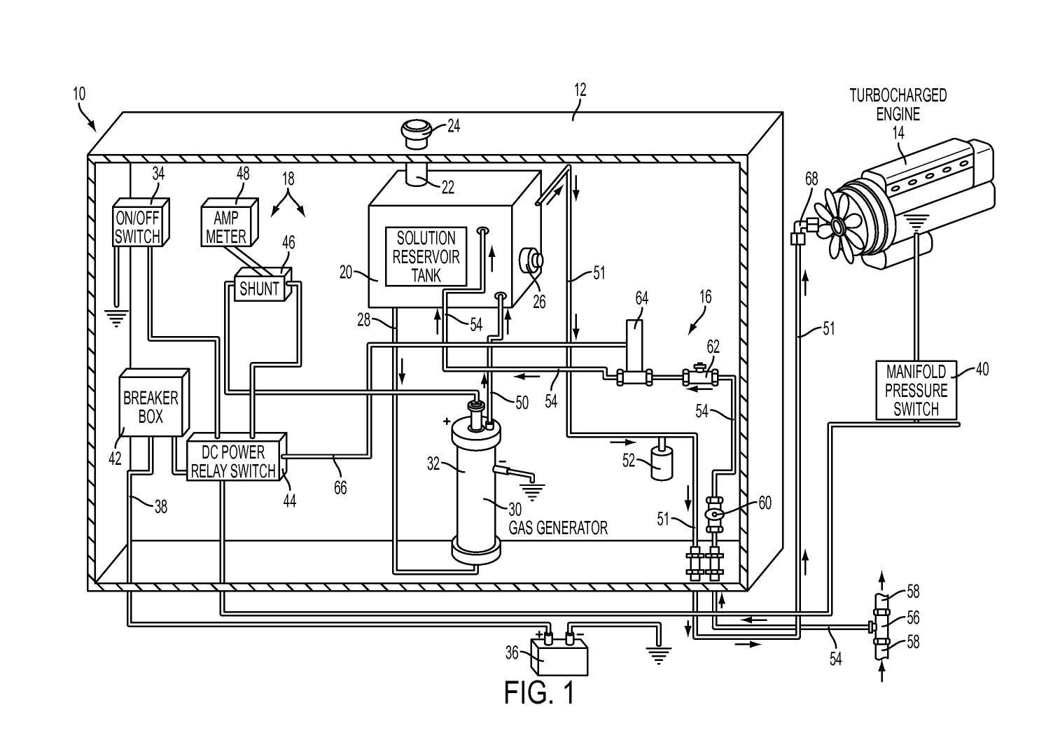

FIG. 1 is a schematic illustration of a pressurized electrolysis system in accordance with embodiments discussed herein. The pressurized electrolysis system is generally identified by reference numeral 10. The pressurized electrolysis system 10 may be mounted in a system housing 12 and adapted for introducing a gas mixture under pressure to an engine. In FIG. 1, the pressurized electrolysis system 10 is shown, by way of example and not limitation, as introducing a gas mixture under pressure to an intake manifold of a turbocharged diesel engine 14. A pressurized electrolysis system 10 in accordance with this disclosure may also be used with other types of engines, such as for example, gasoline engines, diesel engines, natural gas piston driven engines, turbine driven petroleum engines, natural gas burning engines, or jet engines. The pressurized electrolysis system 10 may include an air pressure system 16 and a gas generator system 18.

The gas generator system 18 includes a solution reservoir tank 20 that holds an electrolytic solution. The gas generator system 18 is pressurized by the air pressure system 16, which connects to the solution reservoir tank 20 via the airline 54. The solution reservoir tank 20 feeds the electrolytic solution, via fluid line 28, to the gas generator 30. The gas generator 30 produces a gas or gas mixture by electrolysis of the electrolytic solution. The gas produced by the gas generator 30 is then fed back to the solution reservoir tank 20 via a gas discharge line 50. The gas, when introduced into the fluid in the tank, is cooled and scrubbed to remove any fine particulates. The cooled gas then exits the tank 20 under pressure using the air pressure system 16, to a gas line 51, which is connected to the diesel engine's intake manifold or intake adapter. From there the gas mixes with the intake air stream of the engine 14.

The electrolytic solution that is fed into the gas generator 30 by the solution reservoir tank 20 may be a mixture of ammonium hydroxide and an electrolyte. In one embodiment, the solution contains 1.0-1.5% electrolyte. The electrolyte is typically sodium hydroxide, but other suitable electrolytes may be used depending on the application. In one embodiment, the electrolytic solution includes ammonium hydroxide having a 15% ammonia base. The presence of ammonia in the electrolytic solution provides a number of advantages. In one respect, ammonium hydroxide may be advantageous because of its increased hydrogen content along with the carbon reducing capability of nitrogen, second it may also lower the freezing point of the electrolytic solution eliminating or reducing problematic temperature changes. Unlike isopropyl alcohols and other types of antifreeze, ammonia does not contain carbon. Thus, by the incorporation of ammonia in the solution mixture, carbon pollution is reduced dramatically. Also, the incorporation of ammonia makes the solution mixture less caustic on the engine and on the user who may handle the mixture. The gases produced by electrolysis of the electrolytic solution may be, by way of example and not limitation, a mixture of hydrogen, oxygen, nitrogen, and other gas species. The introduction of these gases into the intake air stream of the engine 14 has been found to enhance the combustion of diesel fuel within the engine 14.

The solution reservoir tank 20 that holds the electrolytic solution may include a solution fill port 22, a fill cap 24 in the top of the housing 12, and a solution level indicator 26 in the side of the tank 20. The solution level indicator 26 indicates a low level of solution in the system 18. The solution reservoir tank 20 typically holds from 2 to 20 gallons of fluid, but may hold smaller or larger amounts depending on the application.

The gas generator system 18 may include an on/off switch 34 for selectively applying electrical power to the gas generator 30. The on/off switch 34 may be connected to a DC power relay 44. When the gas generator system 18 is turned “on”, using the on/off switch 34, power is supplied to the gas generator 30 and gases are generated as described herein. The on/off switch 34 may be used for testing purposes where the engine performance with the gas generator system 18 on is compared to the engine performance with the gas generator system off.

The system 10 may include an inline breaker box 42 to protect the system 18 from power surges or power failures. The inline breaker box 42 may be connected to a vehicle's battery 36 via an electric lead 38. The inline breaker box 42 is typically rated at 50 amps, but may be rated for greater or lesser current amounts depending on the application. The inline breaker box 42 may be connected to a DC power relay 44 and a shunt 46. The shunt 46 may be connected to a positive pole on the gas generator 30 and an amp meter 48. The amp meter 48 may monitor the status of the electrolysis gas produced from the gas generator 30.

The DC power relay 44 may be connected to a manifold pressure switch 40 on the engine 14. The DC power relay 44 may be configured to receive a signal from an engine sensor. The engine sensor/switch may include at least one of a pressure signal from the manifold pressure switch 40 or an oil pressure switch 90. The system 10 may respond to the engine sensor signal by applying variable amounts of power to the gas generator 30 responsive to the engine sensor signal. The oil pressure switch 90 may be included as a safety feature operable to shut off either the gas generator 30a or the flow from the solution reservoir tank 20. This configuration allows the system 10 to automatically respond to the demands of the engine 14 when it is advantageous to do so. Specifically, the manifold pressure switch 40 may sense elevated or otherwise changed pressure levels within the engine 14 that indicate increased demand on the engine 14, such as when the vehicle is climbing a hill. The switch 40 may open or otherwise actuate in response to the elevated or otherwise changed pressure levels to thereby cause the DC power relay 44 to provide additional electrical power to the gas generator system 18 to thereby generate greater amounts of gases for use in the engine 14.

The air pressure system 16, used in combination with the gas generator system 18, may include a high pressure airline 54. The high pressure airline may connect to an airline “T” fitting 56. The fitting 56 may attach to a vehicle's high pressure air line 58, which is typically used for air brakes and/or other air applications on the vehicle. The high pressure airline 58 typically operates at 90 psi, but may operate at greater or lesser pressures depending on the application. The airline 54 may connect to an air regulation device 60. The air regulation device 60 may be a typical pressure regulator which adjusted to regulate the air pressure typically in a range of 30 to 50 psi, depending on the pressure of the intake air introduced into the air intake air stream of the engine. In one embodiment, the air pressure is adjusted to be at least 10 psi and greater than the manifold intake air pressure. For example, if the intake air pressure introduced into the engine is 40 psi, then the air pressure through the air line 54 would be adjusted to be 50 psi or greater. In other embodiments, the air regulation device 60 is a venting valve which controls the line pressure by venting air from the airline 58 in excess of desired pressure. In other embodiments, the air regulation device 60 is a venting valve which controls the line pressure by venting air from the airline 58 in excess of desired pressure. In other embodiments, the air regulation device 60 is a needle valve which may be used to help control flow by restricting the amount of air allowed through the airline 54. In order to restrict or slow down flow, the valve may include an adjustable component resembling a needle which may be positioned so as to prevent an actuator or other device from releasing more air than the system can handle at a given time, thus helping maintain a constant flow rate. As a result of a tightened needle valve, the flow of air not only decreases, but backs up inside the actuator, inhibiting the actuator from generating more pressure because of the increase in resistance. In other embodiments, the air regulation device 60 may be an orifice which controls the flow of pressurized fluid through the airline 58, for example, an airjet.

From the air regulation device 60, the air may be directed through a volume control valve 62 and through an air flow control valve solenoid 64. The volume control valve typically operates at 4 to 5 liters per minute, but may operate at greater or lesser rates depending on the application. The solenoid 64 may connect to the DC power relay 44 via electric lead 66, in one respect, to shut down the air pressure system 16, should there be a loss of air pressure to the system 10. In other respects, the DC power relay 44 may provide variable amounts of power to the solenoid 64 in response to a pressure signal form the manifold pressure switch 40. From the volume control valve 62 and the solenoid 64, the pressurized air enters the solution reservoir tank 20 to thereby pressurize the gas or gas mixture contained therein.

The air pressure system 16 may operate to pressurize the entire gas generator system 18 through the connection to the solution reservoir tank 20. In one respect, the air pressure system 16 pressurizes the gas or gas mixture that is provided to the engine 14. Specifically, the pressurized gas in the solution reservoir tank 20 exits the tank 20 and enters the gas line 51. The gas line 51 exits the housing 12 and connects to a one-way air flow valve 68 attached to the engine's air intake manifold or adapter. The pressurized gas is then mixed with the air introduced into the intake air stream of the engine 14. In another respect, the air pressure system 16 pressurizes gas generator 30. Specifically, the pressurized gas in the solution reservoir tank 20 exerts a pressure on the electrolytic solution that is also located in the solution reservoir tank 20. This pressure is transferred to the gas generator 30 as the gas generator is fed the electrolytic solution through the fluid line 28.

As mentioned above, the DC power relay 44 may provide variable amounts of power to the solenoid 64 in response to a pressure signal form the manifold pressure switch 40. Here, the air pressure system 16, as well as the gas generator system 18, can be made responsive to pressure feedback from the engine 14. Specifically, as the intake air pressure increases, the manifold pressure switch 40 energizes the DC power relay 44 opening the air control solenoid 64 and the generator power control solenoid simultaneously. As the manifold pressure increases, the system pressure increases raising the resistance level of the solution in the gas generator 30. By increasing this resistance level the amount of electrolyte needed for electrolysis to occur may be reduced. It is also noted that the stabilization of certain gas species such as hydrogen and nitrogen can be effected by pressure levels.

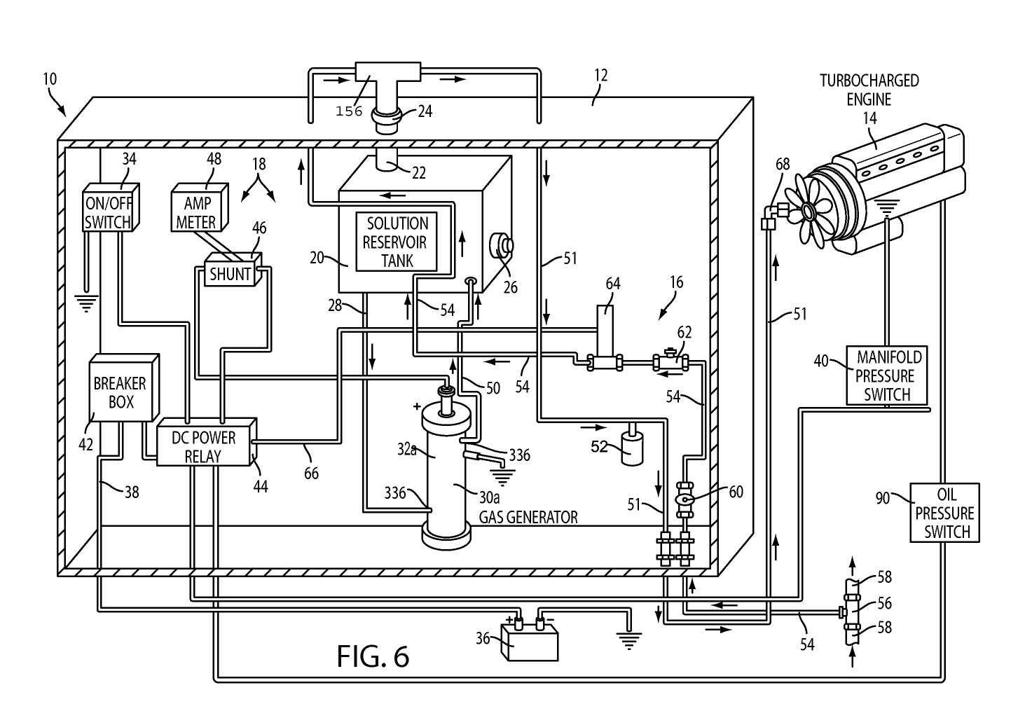

FIG. 6 is a schematic illustration of a combination air pressure and gas generator system 10 in accordance with another embodiment. In various embodiments, airline 54 may not connect directly with solution reservoir tank 20, but may instead connect with a “T” fitting 156 having one fluid line connecting with solution reservoir tank 20. The other fluid line may continue along as in other embodiments described herein as gas line 51 which is connected with the intake manifold of the internal combustion engine 14. The “T” fitting 156 may connect with fill port 22 at fill cap 24 or the “T” fitting 156 may connect through another port into solution reservoir tank 20 such that the solution reservoir tank 20 is still easily fillable through fill port 22 and fill cap 24. The pressurized air in airline 54 may still pressurize the solution reservoir tank 20 and provide transport air to the gas mixture produced by the gas generator 30 through the gas line 51.

With reference to FIGS. 6-11, the solution reservoir tank 20 feeds the solution, via fluid line 28, to the gas generator 30a. The solution resides in fluid communication between the solution reservoir tank 20 and the gas generator 30a. As such, the pressurized gas in the solution reservoir tank 20 exerts a pressure on the solution in the solution reservoir tank 20. This pressure is transferred to the gas generator 30a as the gas generator is fed the solution through the fluid line 28. The gas generator 30a receives and or is fed the solution from the solution reservoir tank 20 via the fluid line 28. The solution enters the gas generator 30a and the inlet 336. An inlet may be positioned at one end of the gas generator 30a and an outlet 336 may be positioned at the opposite end of the gas generator 30a. As shown in FIG. 6, the inlet 336 may be the lower port on the gas generator 30a. In other embodiments, it may be the upper port or the gas generator 30a may be positioned horizontally such that the two ports inlet and outlet 336 are positioned at about the same relative height. Once in the gas generator 30a, the fluid from the tank 20 may undergo electrolysis, producing gas or a mixture of gases that are output from the gas generator 30a via the discharge line 50. Referring to FIG. 6, the housing 32a may provide attachment points for inlet and outlet 336, the inlet 336 receiving the fluid line 28 and the outlet connected to the discharge line 50. Thus, fluid enters through an inlet 336 and undergoes electrolysis inside the elongated body of the gas generator 30a. The gas or mixture of gases produced by the electrolysis exits the gas generator 30a through an outlet or opposing port 336, which is positioned on the housing 32a on the opposite end from the first port 336.

As mentioned above, system 10 may receive feedback from engine sensors that aid in the control of the system 10 and ultimately the delivery of the mixed pressurized gas to the intake manifold of engine 14. The DC power relay 44 may provide variable amounts of power to the solenoid 64 in response to a pressure signal from the manifold pressure switch 40 as one example of the engine sensor. Another engine sensor may include an oil pressure switch 90. Changes in the oil pressure may direct the solenoid 64 to reduce or increase the flow of the mixed pressurized gas to the intake manifold of engine 14. For example, at startup the DC power relay may receive a signal from the oil pressure switch indicating a low oil pressure. In response the DC power relay may cause the solenoid to discontinue the flow, thereby shutting off the flow of mixed pressurized gas. As such, the air pressure system 16, as well as the gas generator system 18, can be made responsive to engine sensor feedback provided by the engine 14.

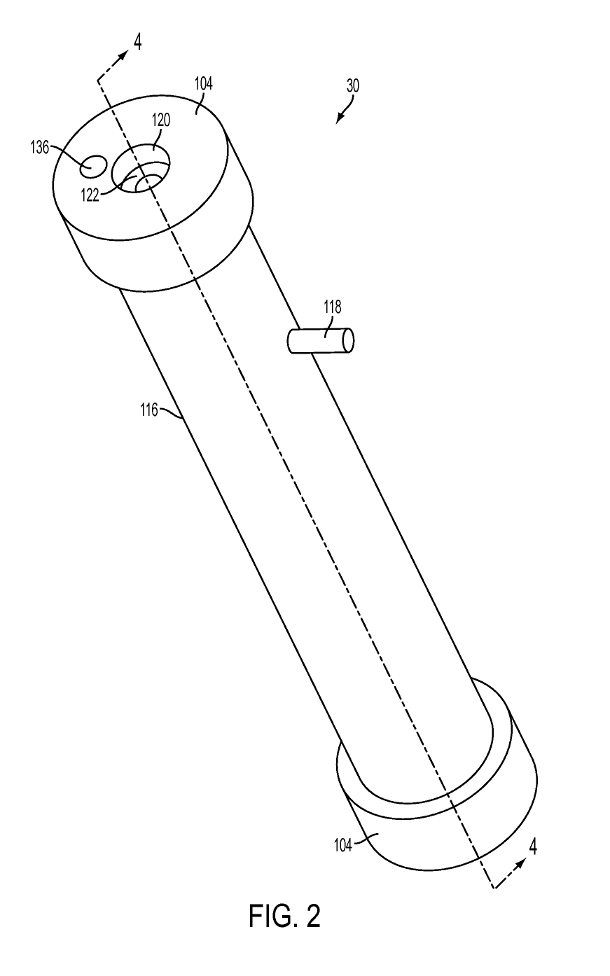

The gas generator 30 generally includes a generator housing 32 that contains a plurality of spaced apart anode and cathode tubes. The anode and cathode tubes are shown in greater detail in FIG. 2 through FIG. 5B. FIG. 2 is a perspective illustration of a gas generator 30 embodiment. The gas generator embodiment shown in FIG. 2 includes an elongated cylindrical body that extends between two end caps 104. As described above, the gas generator 30 may be incorporated into a system 10 such that the gas generator 30 is fed fluid from the solution reservoir tank 20 via the fluid line 28. Once in the gas generator, the fluid from the tank 20 may undergo electrolysis, producing gas or a mixture of gases that are output from the gas generator 30 via the discharge line 50. Referring to FIG. 2, the end caps 104 provide attachment points for the fluid line 28 and the discharge line 50. Thus, fluid enters through a first end cap 104 and undergoes electrolysis inside the elongated body of the gas generator 30. The gas or mixture of gases produced by the electrolysis exit the gas generator 30 through a second end 104, which is opposite from the first end cap 104.

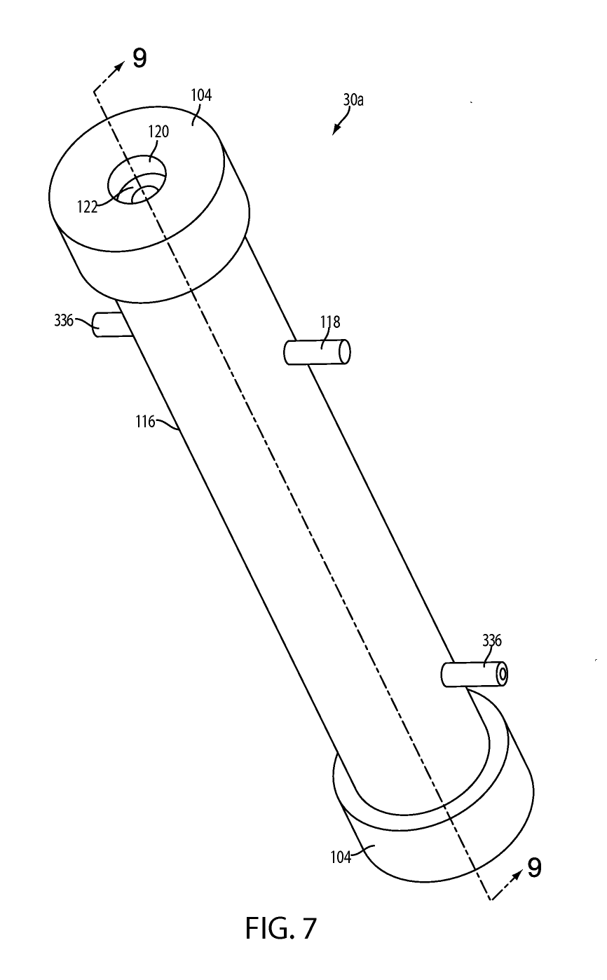

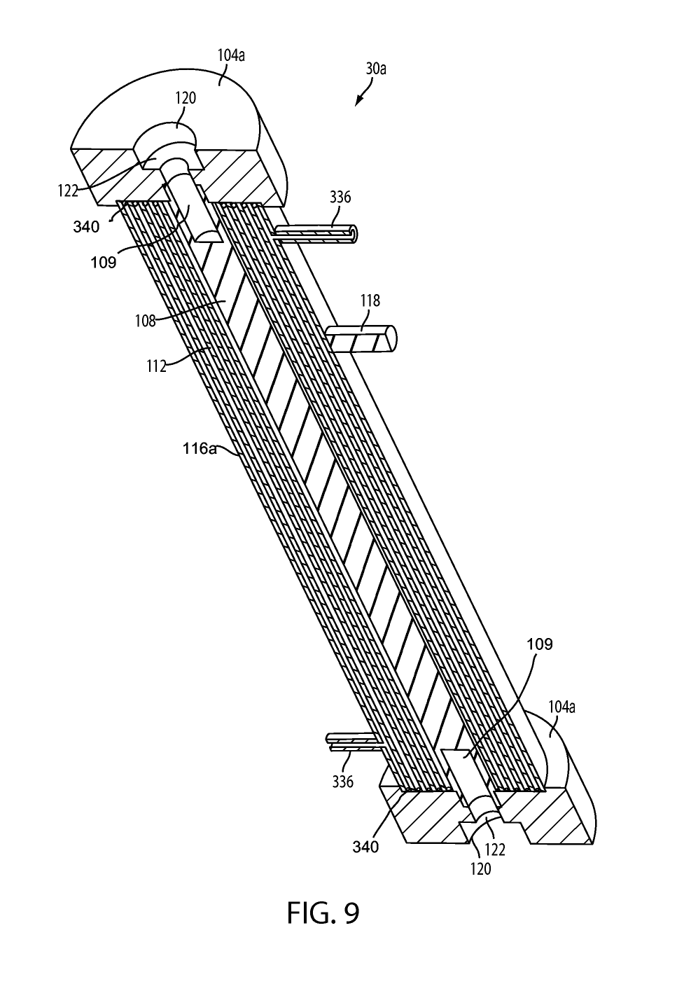

FIG. 7 is a perspective illustration of an embodiment of the gas generator 30a shown in FIG. 6. As shown, the ports 336 (e.g. inlet and or outlet) pass through cathode tube 116. The cross section of FIG. 7 shown in FIG. 9 illustrates the passage that ports 336 form in the side wall of the cathode tube 116. This passage allows the solution to enter the space located between each of the concentric tubes, the anode bar 108, and cathode tube 116. In accordance with various embodiments, the first and second end caps 104a may only have a singular aperture 120. The single aperture 120 may include a counter bore 122. The end caps 104a may otherwise have no passages to the interior of the gas generator 30a. This is in contrast to the gas generator 30, shown in FIGS. 1-6, which provided the inlet and the outlet through the end caps 104. Other attributes, including the ground contact 118, may be similar to the other embodiments discussed herein.

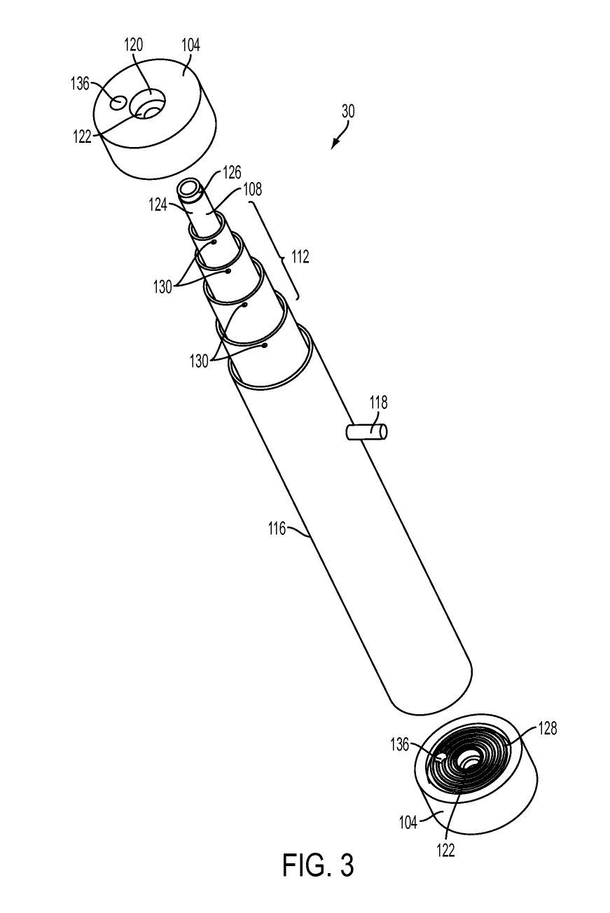

FIG. 3 is an exploded view of the gas generator 30 shown in FIG. 2. As can be seen in FIG. 3, gas generator 30 has an asymmetrical electrode configuration that includes an anode bar 108 that extends along the central axis of the elongated cylindrical body of the gas generator 30. The anode bar 108 is surrounded by a number of concentric bipolar electrically conductive tubes 112 which function as floating bipolar electrodes that are contained within the body of the gas generator 30. A cathode tube 116 surrounds both the anode bar 108 and the tubular bipolar electrodes 112 to thereby form an exterior of the gas generator 30. The anode bar 108, the bipolar conductor tubes 112, and the cathode tube 116 provide electrically conductive surfaces that provide for electrolysis of the fluid introduced into the gas generator 30. Here, the central anode electrode 108, the surrounding concentric bipolar tubular electrodes 112, and the outer most tubular cathode electrode 116 are insulated from each other, when the solution is absent, but when the solution containing the electrolyte is present, form a series connection electrical pathway that alternates between electrodes and solution, when power is applied. The cylindrical configuration of the anode bar 108, the tubular bipolar electrodes 112, and the outer tubular cathode 116 provides an advantageous usage of surface area and, in that regard, an electrically efficient and lower temperature electrolytic reaction.

In one embodiment, the gas generator 30 has a cathode tube 116 that makes up the outer shell with an outside diameter of 1.750 inches. Here, the gas generator 30 may include four tubular bipolar electrodes 112 having the following outside diameters of: 0.75 inch, 1.0 inch, 1.25 inch, and 1.5 inch. These four tubular bipolar electrodes also have a collection of small holes 130 located near each end to aid the passage of solution or gas when present. The holes 130 are shown as being aligned for purposes of illustration and by way of example and not limitation. In certain embodiments, advantages may be gained, such as avoiding electrical arcing, by orienting the electrodes such that the holes 130 are not aligned. The central most electrode is an anode consisting of a metal bar with an outside diameter of 0.500 inch. In this construction, the tubes are spaced apart by 0.065 inch. These dimensions provide an advantageous configuration for specific concentration of electrolyte within the solution. These dimensions may be adjusted with corresponding changes in electrolyte concentration. A gas generator 30 consistent with this disclosure may have other dimensions depending on the application.

The anode bar 108 and the cathode tube 116 each provide electrical contacts for the gas generator 30. A ground contact 118 is provided as a lead or other connection point that extends from the exterior surface of the cathode tube 116. Power is provided to the gas generator 30 through an electrical contact at one end of the central anode bar 108. The central anode bar 108 the tubular bipolar electrodes 112 and the outer tubular cathode electrode 116 are insulated from one another by the mounting grooves 128 in the plastic end-caps 104. Current flows from the anode bar 108 through the dissolved electrolyte and the tubular bipolar electrodes, to the outer cathode tube 116, thus allowing electrolysis to take place.

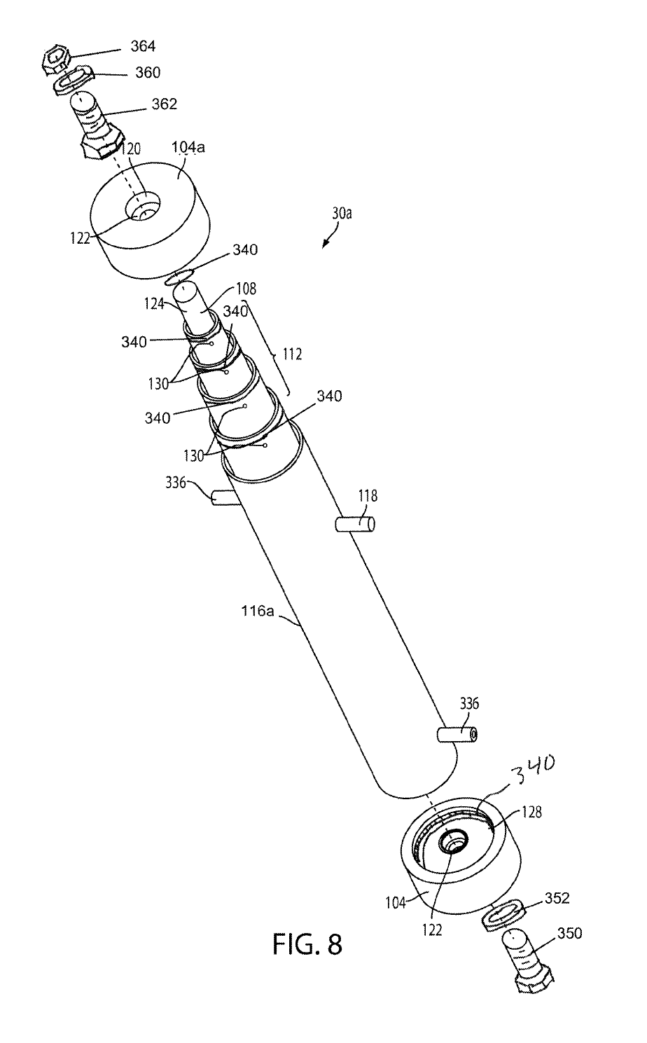

FIG. 8 is an exploded view of the gas generator shown in FIG. 7. In various embodiments, the gas generator 30a may have an asymmetrical electrode configuration that includes an solid anode bar 108 that extends along the central axis of the elongated cylindrical body of the gas generator 30a similar to the other embodiments discussed herein. The anode bar 108 may have threaded blind holes 109 operable to receive threaded stud 360 on one end and the threaded bolt 350 and washer 352 on the opposite end. Bolt 350 and washer 352 may compress the end cap 104a against the cathode tube 116. In various embodiments, any fastener suitable for electric conductivity may be utilized. The threaded stud 360 may receive nut 364 and washer 362 in order to fasten electric leads to the anode bar 108 and or compress the end cap 104a against the cathode tube 116. The anode bar 108 is surrounded by a number of concentric bipolar electrically conductive tubes 112 which function as floating bipolar electrodes that are contained within the body of the gas generator 30a. The conductive tubes 112 may be separated from one another in such a way as to contain the solution between the spaces disposed in between each wall. In this way, the ends of the bipolar conductor tubes 112 are encapsulated and evenly spaced with O-rings that may be placed between the tubes 112 on each end. As shown in FIGS. 8 and 9, the conductive tubes 112 are separated by a plurality of gaskets or O-rings 340 located at each end of the conductive tubes 112. The O-rings 340 may be positioned between holes 130 and the end of the conductive tube 112 such that the O-rings do not seal the solution contained within the conductive tubes 112 off from passing between conductive tubes. As the holes 130 may be scattered, the O-rings 340 may also be located on an end of the conductive 112 without apertures 130. The plurality of holes 130 may be located near one or both ends to aid the passage of solution or gas between concentric cylinders. The holes 130 are shown as being aligned for purposes of illustration and by way of example and not limitation. In certain embodiments, advantages may be gained, such as avoiding electrical arcing, by orienting the electrodes such that the holes 130 are not aligned. The anode bar 108 may be sealed to the end caps 104a by O-rings 340 placed in the O-ring seats 126 on each end 124 of the anode bar 108. The cathode tube 116 is centered by being overlapped on each end by the end caps 104. The cathode tube 116 may be sealed on each end by an O-ring placed in a precut groove 129 around the perimeter wall 131 defining the perimeter of a recessed surface 128a in each end cap 104a.

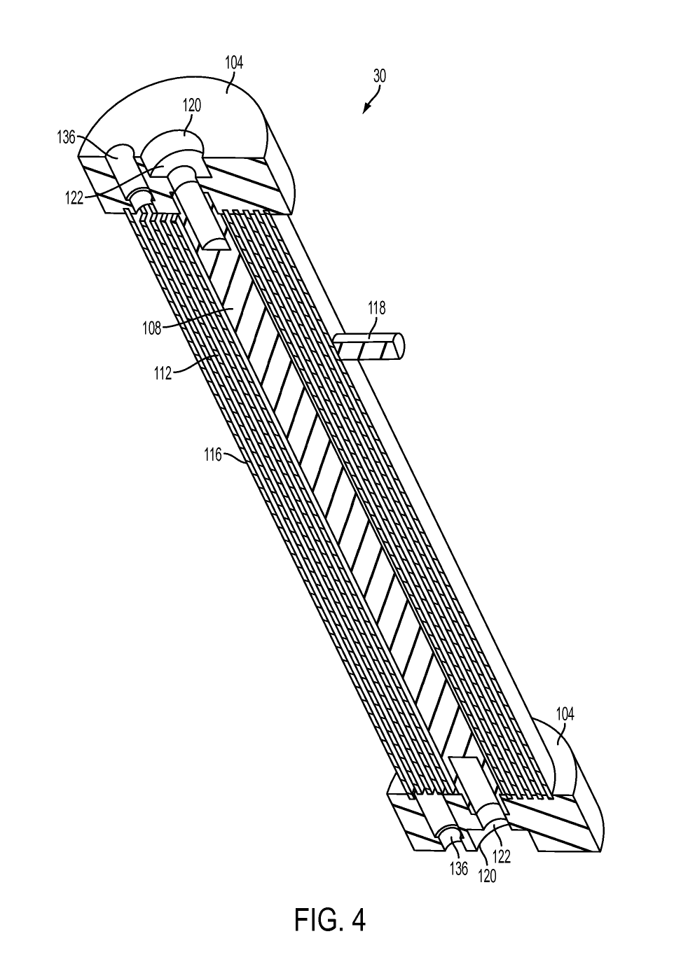

FIG. 4 is a cross sectional illustration of the gas generator 30 embodiment shown in FIG. 2. As can be seen in FIG. 4, the end caps 104 encapsulate the ends of the anode bar 108, the bipolar conductor tubes 112 and the cathode tube 116. The anode bar 108 is centered by holes 120 in each of the end caps 104. Each hole 120 includes a countersink 122 this recessed within the hole 120. The countersink 122 provides a stopping surface for a nut and washer combination that connects the anode bar 108 to the end caps 104. The anode bar 108 may be sealed to the end caps 104 by O-rings placed in the O-ring seats 126 on each end 124 of the anode bar 108. The ends of the bipolar conductor tubes 112 are encapsulated and evenly spaced with O-rings that may be placed between the tubes 112 on each end. The cathode tube 116 is centered by being overlapped on each end by the end caps 104. The cathode tube 116 may be sealed on each end by an O-ring placed in precut grooves 128 in each end cap 104.

The ends of both the cathode tube 116 and the bipolar conductor tubes 112 may be completely encapsulated and sealed with a sealant into the end caps 104, preventing the ends of these electrodes from coming into contact with the solution. This configuration may have the advantage of lowering the current and/or power consumption of the gas generator 30, and may have the advantage of lowering the operational temperature of the electrolytic fluid. Specifically, the sealing or other equivalent protection of the ends of the electrodes may prevent the edges of the metal surfaces from focusing the electric field which could potentially result in an electrical arc. An electrical arc, if present, could potentially introduce high temperature gases, result in both electrode and cap erosion or destruction, and/or ignite gases already made by the electrolysis thus preventing hydrogen gas delivery to the exhaust port of the gas generator 30. Thus, electrical arcing may result in wasteful consumption of electrical current or, more specifically, electrical current consumption that is not utilized for gas production that gets delivered to the engine. By suppressing electrical arcing at the ends of the electrodes, disclosed embodiments may avoid these disadvantages and, in general, increase the amount of electrolysis that occurs at the electrodes.

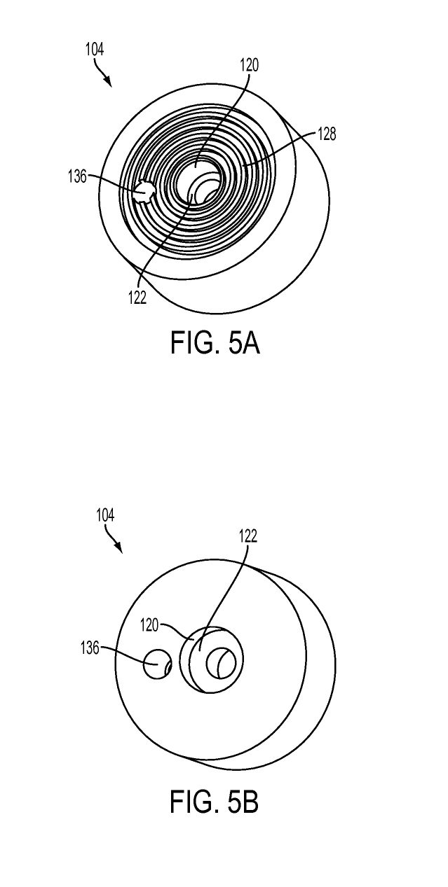

The end caps 104 can be seen in greater detail in the enlarged perspective views of FIGS. 5A and 5B. FIG. 5A is a perspective view of an end cap 104 that shows an interior facing surface including the pre-cut grooves 128. FIG. 5B is a reverse perspective view of the end cap 104 shown in FIG. 5B. FIG. 5B shows an exterior facing surface of the end cap 104. The end caps 104 are adapted to be compressed to the anode bar 108, the bipolar conductor tubes 112 and cathode tube 116. The assembly may be held together by installing studs into threaded holes in each end 109 of the anode bar 108. The studs protrude through the end cap holes 120 then washers and nuts are torqued to appropriate specifications to complete the assembly. Fittings 136 fastened to the cathode tube 116 allow fluid to flow into the bottom of the gas generator 30 and the gas to exit the top of the gas generator 30.

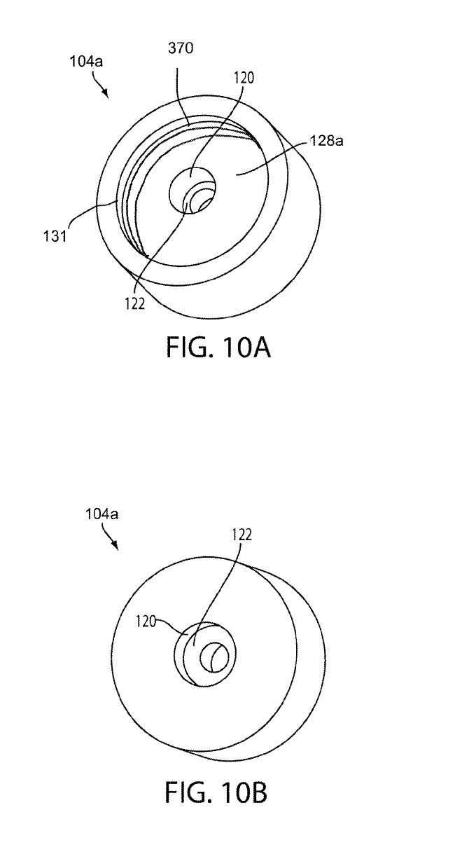

FIGS. 10A and 10B are a perspective view and a reverse perspective view of the end cap 104a shown in FIG. 7. The end cap 104a may have a recessed surface 128a. The surface 128a may be a flat surface recessed within a cylindrical wall 131. The cylindrical wall may have a groove 370 extending around the wall that is operable to receive an O-ring. The recessed surface 128a may be flat. The flat recessed surface 128a may be operable to receive an end of the cathode tube 116 and the concentric bipolar electrically conductive tubes 112 with the O-rings positioned between. The O-rings and the concentric bipolar electrically conductive tubes 112 may be able to lay substantially flat on the recessed surface 128a. This engagement configuration between the cathode tube 116, the concentric bipolar electrically conductive tubes 112, and the O-rings positioned between (as shown in the cross section FIG. 9) may be operable to isolate the end cap 104a from the fluid contained within the cathode tube 116 and the concentric bipolar electrically conductive tubes 112. Not to be limited by theory in any way, but it is believed that this isolation prevents energy loss between the liquid and the end cap 104a or the cathode tube 116 and the concentric bipolar electrically conductive tubes 112 and the end cap 104a. The prevention of energy loss keeps energy within the fluid but keeps temperatures down in the fluid. In some instances, this configuration may lower operating temperatures by 25-30° F. over other embodiments of the end caps discussed herein. Utilizing the O-rings between the cathode tube 116 and each of the concentric bipolar electrically conductive tubes 112 maintains a high-tolerance substantially equal distance spacing which further improves efficiencies of the system.

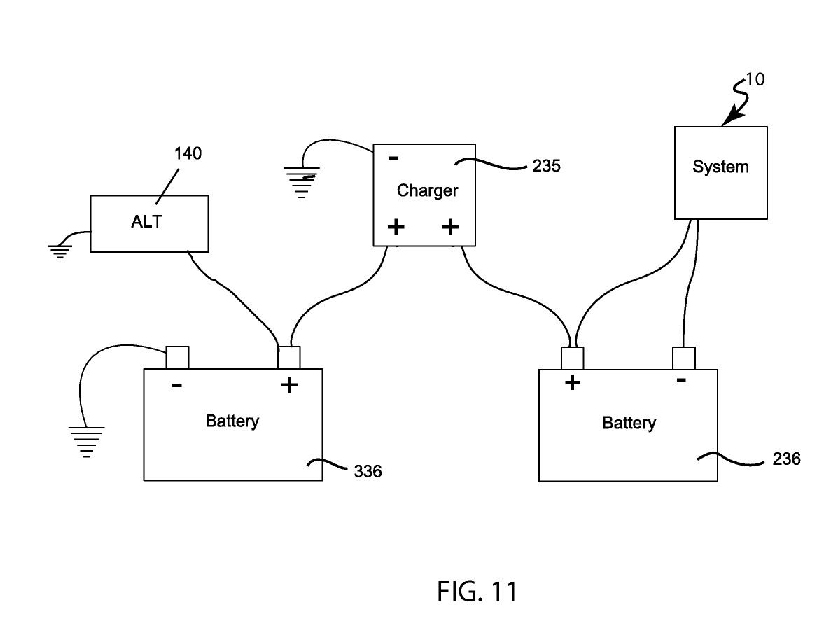

The system 10 may be connected to a power source that keeps the gas generator 30a of system 10 receiving a constant power at a low amperage input. A controlled lower amperage input into the system 10 causes a reduction in the output gas temperature from the gas generator 30a. A decrease in the temperature of a gas causes a corresponding increase in the density of the gas and reduction in other system inefficiencies. A higher density of gas may be inputted into the internal combustion engine 14. FIG. 11 is a schematic illustration of an electrical supply circuit for providing a power input to the combination air pressure and gas generator system 10. The circuit illustrated in FIG. 11 may replace the power supply 36 illustrated in FIGS. 1 and 6. In this embodiment, the vehicle battery 36 may no longer feed directly into the system 10. Alternatively, a primary 12v battery 236 with an output capacity of between 125 and 150 amp hours, may be connected to system 10. During continuous usage the voltage is drawn down on the battery 236. The low voltage causes undesirable effects to the current output which has a tendency to increase the temperature of the solution. A 12v dc power supply unit 235 with a maximum output of 15 amps may be connected between a secondary battery 336 and the battery 236. The battery 336 may be operable as a 12v dc power source for the power supply unit 235. The power source may be limited to low current output such as 15 amps. The power supply unit 235 is automatically controlled by the input voltage of the secondary battery supply 336.

The secondary battery supply 336 may be the vehicles power supply or the secondary battery supply 336 may be a supplemental supply not in use by other systems. The secondary battery supply 336 may supply an output amperage between 0 and 300 amps to the power supply unit 235. The secondary battery supply 336 may be charged by the alternator 140 of the vehicle. As the secondary battery supply 336 is charged its voltage is increased to 13.2v. Meeting the voltage threshold may activate the connecting power supply 235 which provides a low current supply to primary battery 236. By keeping primary battery 236 sufficiently charged there is minimal voltage drop in batter 236. Without a voltage drop there is no negative effect on the battery 236 current output. This keeps the gas generator at a constant power input and also a reduced current input. The result being a reduction in the output gas temperature and an increase in the output gas density or other efficiencies.

Embodiments discussed herein may be implemented as system or kit adapted for mounting on a vehicle or mounting under the hood and next to a vehicle's diesel engine. Embodiments provide an air pressure system incorporated into a gas generator system that may be inexpensive and/or easy to install under the hood of a truck, tractor with trailer and similar type of vehicles and next to a diesel engine. The combination of systems can also be used with mobile and stationary engines. While embodiments discussed herein used with a diesel engine, they can also be used with bio-diesel, compressed natural gas, powdered coal, and gasoline operated vehicles. Also, the systems can be used independently or in conjunction with other power sources to provide the gas mixture to other power generating systems, such as fuel cells, steam engines, and hydrogen engines or for other uses, such as heating ovens, ranges and infrared catalytic heaters. The mixture of gases introduced under pressure into the intake manifold may greatly increase vehicle mileage per gallon of fuel, may improve fuel combustion at a low combustion temperature with reduced hydrocarbon emissions, may reduce greenhouse gas emissions, and may reduce engine maintenance.

Embodiments disclosed herein may provide any of a number of advantages, including reducing fuel consumption of on and off-road diesel engines; reducing the carbon and NOX output of diesel engines on and off-road; reducing service downtime due to regeneration of the diesel particulate filters (dpf) used in the diesel industry for the reduction of carbon output; reducing the amount of electrolyte used compared to other designs thereby lowering the ph. level and increasing the life of the system; decreasing turbocharger speed and exhaust temperatures; decreasing the soot content of the diesel particulate filers used for the reduction of carbon output of diesel engines thereby reducing or eliminating the fuel consumption used to perform forced regenerations. Disclosed embodiments feature an electrolytic solution include that may not get hot enough to boil or vaporize the solution, both potentially yielding a dryer exhaust gas and less power being lost due to unnecessary heating of the solution. In cold winter environments, the need for heating may be reduced or may not be required due to the antifreeze like properties of the ammonia that is added to the solution. Furthermore, unlike prior art electrolytic generators where reversing the polarity of the electrical system and swapping the anode and cathode connection of the cylindrical gas generator yields zero or trace amounts of gas output, this may not occur in certain embodiments discussed herein.

Unlike typical configurations and systems, embodiments disclosed herein reduce or minimize the need for a coolant system for the gas generator and/or for the fluid reservoir because the disclosed generator design (sealing ends of tubes) may reduce heat output. Certain embodiments may reduce or minimize the need for a reservoir or accumulator for generated gases because disclosed embodiments generate gases only on demand of the engine, varying with load on the engine. Certain embodiments may reduce or minimize the need for increased wattage to the generator in order to generate sufficient volumes of gases by curbing loss of energy in the form of heat. Certain embodiments may reduce or minimize the need for a heating system for the electrolyte solution due to the disclosed chemical composition of electrolyte (NH3—H2O). Certain embodiments reduce or minimize the need for a drying or catchment system to arrest entrained droplets of electrolyte solution in the generated gases because disclosed embodiment features low heat in the generator, cooling back through reservoir, and dry air from vehicle's air pressure system that can prevent entrainment of droplets.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed.

We claim:

1. A gas generator system for use with a diesel engine, comprising
a gas generator having
a body;
a first end cap having a flat recessed surface connected to a first end of the body; and
a second end cap connected to a second end of the body;
an anode bar that extends along a central axis of the body;
a plurality of concentric bipolar conductive tubes that surround the anode bar and seat on the flat recessed surface of the first end cap; and
a cathode tube that surrounds the bipolar conductive tubes and forms an exterior surface of the body.

2. The gas generator system of claim 1, wherein the body includes an input that extends radially from the side wall that receives a fluid that undergoes electrolysis.

3. The gas generator system of claim 2, wherein the body includes an output extending radially from the side wall that discharges a gas mixture produced by the electrolysis of the fluid.

4. The gas generator system of claim 3, wherein the a plurality of concentric bipolar conductive tubes are separated by o-rings positioned at a first and at a second end of each of the concentric bipolar conductive tubes such that the o-rings separate the tubes from contacting one another.

5. The gas generator system of claim 4, wherein the body includes an outwardly extending ground connection; and the anode bar includes a power connection disposed on an end thereof.

6. The gas generator system of claim 5, wherein
the anode bar the bipolar conductive tubes and the cathode tube are insulated from each other such that they form a pattern of conductive surfaces that alternate between electrode and electrolytic fluid when power is applied.

7. The gas generator system of claim 6, further comprising
a reservoir for holding the fluid mixture;
a conduit establishing fluid communication between the reservoir and the input on the gas generator body;
a pressurizer in fluid communication with the reservoir such that the pressurizer applies a pressure a gas pressure to the reservoir increasing the volume of the gas mixture generated by the gas generator;
a conduit establishing fluid communication between the reservoir and an intake manifold of an internal combustion engine causing the pressurized gas mixture to be introduced into the intake manifold of an internal combustion engine.

8. The gas generator system of claim 1, wherein the gas mixture generated by the gas generator is selected from the group comprising hydrogen, oxygen, and nitrogen and other gas species.

9. The gas generator system of claim 3, wherein the outlet of the gas generator is in fluid communication with the reservoir such that the gas produced by the gas generator is fed back into the reservoir.

10. The gas generator system of claim 1, wherein the gas generator comprises
one or more holes through each of the a plurality of concentric bipolar conductive tubes that surround the anode bar thereby placing the volumes between each of the plurality of concentric bipolar conductive tubes in fluid communication with one another.

11. The gas generator system of claim 1, further comprising a first direct current power supply in communication with a charger unit that is in communication with a second direct current power supply which is the same direct current power supply as used by the engine and is also in communication with the alternator on the engine such that the engine charges the second direct current power supply and the second direct current power supply charges the first direct current power supply via the charger unit at about 15 amps.

12. The gas generator system of claim 1, further comprising
a relay which in communication with an engine sensor, wherein the relay receives feedback from the engine sensor directing a solenoid, positioned in line between the reservoir and the engine, to increase or decrease the flow of fluid from the reservoir.

13. The gas generator system of claim 1, wherein
the engine sensor includes one of at least a manifold pressure senor or an oil pressure sensor.

14. The gas generator system of claim 1, further comprising
wherein the sensor a manifold pressure senor operable to direct the solenoid to increase the flow of fluid from the reservoir when the manifold pressure drops.

15. The gas generator system of claim 1, wherein
wherein the sensor a oil pressure sensor operable to direct the solenoid to cutoff the fluid from the intake manifold in response to a low oil pressure.
